(19) United States
(12) Patent Application Publication
(10) Pub. No.: US 2020/0406809 A1
(43) Pub. Date: Dec. 31, 2020

(54) Towable Fluid Storage Tank Trailer

(71) Applicant: Korey L. Peters, Oklahoma City, OK (US)

(72) Inventor: Korey L. Peters, Oklahoma City, OK (US)

(21) Appl. No.: 16/454,338

(22) Filed: Jun. 27, 2019

(51) Int. Cl. B60P 3/22; G01F 23/00

(52) U.S. Cl. CPC B60P 3/2215; B60R 3/00; G01F 23/0007

(57) ABSTRACT

A towable fluid storage tank trailer comprising a cylindrical horizontal storage tank with a cylindrical walled outer structure with ends creating an inner cavity with an external fluid connection and access point to the inner cavity, a tank support structure substantially surrounding and engaging the underside of the tank and the tank disposed within a support structure, tank coupling members engaging the topside and securing the tank in a desired position on the trailer assembly, and towable trailer assembly with skids, longitudinal retention members, lateral retention members, a kingpin for engaging the tow vehicle, and a rear wheel axle assembly whereby the storage tank is horizontally disposed within the tank support structure and is removably coupled to the support structure that is rigidly affixed to the towable trailer assembly where various types of caustic and non-caustic fluids are filled and transported.

### CROSS-REFERENCE TO RELATED APPLICATIONS

None

### FIELD OF THE INVENTION

The invention generally relates to an apparatus for receiving, transporting and offloading a fluid in the oil field. In particular, the invention relates to an apparatus for receiving, transporting, and offloading of caustic fluids while trapping and neutralizing noxious, caustic, and potentially explosive fumes and vapors utilizing a scrubber wherein the fumes and vapors are combined with a neutralizing agent to reduce and potentially the eliminate any danger posed by the fumes and vapors during the loading, transporting, and unloading of the fluid.

### BACKGROUND

A towable fluid storage tank trailer is designed to carry liquefied loads, dry bulk cargo, or gases. Many variants of the towable fluid storage tank trailer exist due to the wide variety of fluids that can be transported. The tank trailer transports a wide variety of fluid material such as liquid sugar, molasses, milk, wine, juices, water, gasoline, diesel, oil field products, and industrial chemicals. The tank trailers may be insulated, pressurized, or lined depending on the fluid to be transported. Tank trailers are typically constructed of materials tailored to what products they are transporting. Typical materials include aluminum, carbon steel, stainless steel, and fiberglass reinforced plastic. Tanker trailers are used in many industries as described above which dictate their construction and the type of materials.

Specifically, in the petroleum industry, the tanker trailer transports multiple liquids including, but not limited to water, salt water, petroleum hydrocarbons, chemicals, acids, and fracking fluids. Tanker trailers may require a liner to support the transportation of chemicals, acids, and fracking fluids due to their caustic or reactive nature. Some tanker trailers with and without liners may require repair to the interior of the tank after the transportation of the aforementioned materials to perform repairs, personnel must enter the tank, which is a confined space, exposing the personnel to a hazardous environment from the material residue. Additionally, the current tanker trailer has limited capability to address the build-up of vapors and fumes as the tanker trailer is loaded, which vapors and fumes could be potentially be explosive and deadly to loading personnel and other surrounding personnel. The current tank trailer design poses many threats to personnel when loading and repairing and to the environment if the vapors and fumes were to escape in sufficient quantities without being neutralized.

### SUMMARY OF THE INVENTION

The present invention overcomes these shortcomings by providing a towable fluid storage tank trailer that is chemical and acid resistant and can neutralize the hazardous vapors and fumes created by the chemicals. Additionally, the tank trailer has no liner to repair, thereby minimizing personnel exposure to a hazardous environment inside the tank trailer. The towable fluid storage tank trailer may comprise a chemical and acid resistant cylindrical storage tank, a towable trailer, and a scrubber to neutralize the hazardous vapors and fumes when the tank is receiving its fluid load for transport. The storage tank is horizontally disposed along a substantially longitudinal axis within the tank support structure and is removably coupled to the towable trailer.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a perspective view of a towable fluid storage tank trailer.

FIG. 2 is a perspective view of a towable fluid storage tank trailer with the tank and associated components removed.

FIG. 3 is a view of a front-end of the towable fluid storage tank trailer.

FIG. 4 is a view of a right-side of the towable fluid storage tank trailer.

FIG. 5 is a view of a rear-end of the towable fluid storage tank trailer.

FIG. 6 is a view of a left-side of the towable fluid storage tank trailer.

### DETAILED DESCRIPTION OF THE INVENTION

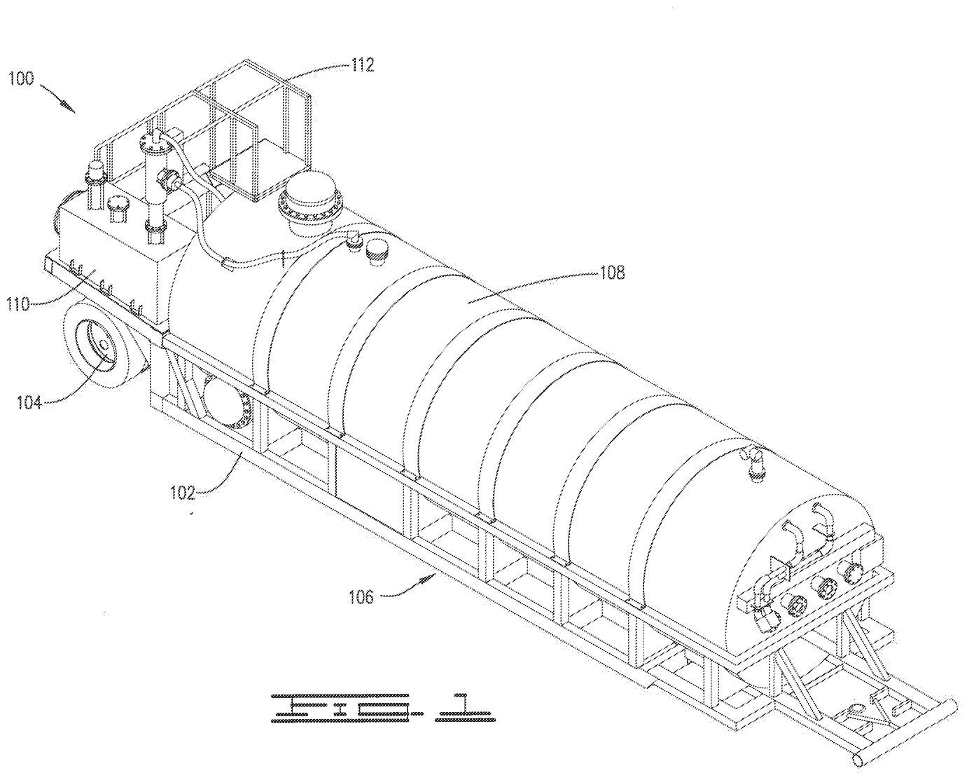

FIG. 1 is a perspective view of a towable fluid storage tank trailer 100. The towable fluid storage tank trailer 100 may comprise a trailer assembly 102 with a rear axle assembly 104, a tank support structure 106, a tank 108, a scrubber system 110, and a stairway 112. In the preferred embodiment, the tank 108 may be disposed horizontally along a longitudinal tank support structure 106 which may be removably affixed to the trailer assembly 102. Preferably, the rear axle assembly 104 may be affixed to the rear of the trailer assembly 102. The scrubber system 110 may be positioned on a rear platform 226, which may be disposed above the rear axle assembly 104. The stairway 112 is preferably positioned next to the scrubber system 110 on the rear platform 226 and may be centered relative to the tank 108, with the stairway 112 entrance on the trailer rear end 500 allowing access from the ground to the top of the tank 108.

The tank 108 may be a hollow cylinder with rigidly affixed ends and may be selected from ferrous and non-ferrous metals, composites, carbon fiber, fiberglass, and polypropylene. In the preferred embodiment, the tank 108 is a polypropylene hollow cylinder with rigidly affixed proximate and distal polypropylene ends creating a monolithic tank with a cavity therein to receive caustic and non-caustic fluid to be transported.

The rear axle assembly 104 may be removably affixed to the trailer assembly 102 to engage the ground for rolling movement during transport operations. The rear axle assembly 104 may be disposed aft of the tank support structure 106, and tank 108 and below the rear platform 226. The rear axle assembly 104 may be disposed to allow the towable fluid storage tank trailer 100, when disconnected from the tow vehicle, to engage the ground via the frame skids 202 and 204 without inclination caused by the rear axle assembly 104. Further, the rear axle assembly 104 may be disposed to prevent trailer assembly 102 inference with the ground when connected to a tow vehicle for and during transportation.

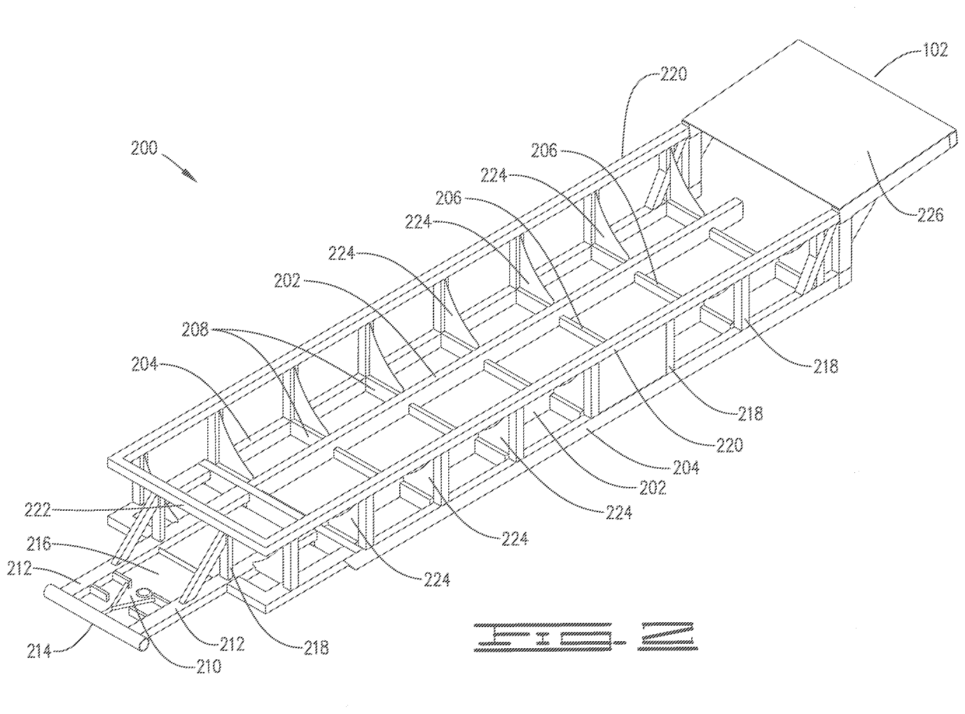

FIG. 2 is a perspective view of the trailer structure 200 of the trailer assembly 102 without the tank 108. The trailer assembly 102 may comprise the trailer structure 200 with the upper coupler 210 and the tank support structure 106 that will retain and support the tank 108 and prevent the tank 108 from moving during transportation.

In this view, the tank 108, the scrubber system 110 and stairway 112 are removed from the trailer assembly 102. In the preferred embodiment, the trailer structure 200 may have two internal longitudinal frame skids 202 and two external longitudinal frame skids 204 that substantially extend the length of the of the trailer structure 200. Both the internal longitudinal frame skids 202 are disposed between and parallel to the two external longitudinal frame skids 204. The longitudinal frame skids 202 and 204 allow the towable fluid storage tank trailer 100 to be removed from the towing vehicle and placed on the ground at an oil site or other storage facility minimizing the risk of damaging the tank 108. The longitudinal frame skids 202 and 204 may allow the trailer to be moved around at an oil site without the use of tow vehicle without damaging the tank 108. The internal longitudinal frame skids 202 may be rigidly affixed to each other through a plurality of internal horizontal crossmembers 206. In the preferred embodiment, the internal horizontal crossmembers 206 may be disposed and spaced between the internal longitudinal frame skids 202. Preferably, the internal horizontal crossmembers 206 are welded to internal longitudinal frame skids 202. Other methods for rigidly affixing the internal horizontal crossmembers 206 to the internal longitudinal frame skids 202 known may be used by one skilled in the art.

A plurality of external horizontal crossmembers 208 may rigidly affix the internal longitude frame skids 202 to the external longitudinal frame skids 204. In the preferred embodiment, the external horizontal crossmembers 208 are welded to rigidly affix them to the internal longitudinal frame skids 202 and the external longitudinal frame skids 204. However, one skilled in the art may choose other methods for rigidly affixing the external horizontal crossmembers 208 to the frame skids 202 and 204.

The trailer frame 212 may be rigidly affixed to and integrated with both internal longitudinal frame skids 202 and external longitudinal frame skids 204. The trailer frame 212 extends beyond the horizontal lateral member 222 above to form an upper coupler 210. In the preferred embodiment, the upper coupler 210 may consist of a portion of the trailer frame 212 extending from the internal longitudinal frame skids 202, a trailer upper coupler crossmember 214, and a trailer upper coupler mounting plate 216.

The trailer upper coupler crossmember 214 may be rigidly affixed to the proximate ends of the trailer frame 212. Preferably, trailer upper coupler mounting plate 216 is disposed between trailer upper coupler crossmember 214 and the trailer frame 212. In an alternative embodiment, the trailer upper coupler mounting plate 216 may be rigidly affixed above and below the trailer upper coupler crossmember 214 and the trailer frame 212. In the preferred embodiment, the trailer upper coupler crossmember 214 is welded within and to the proximate end of the trailer frame 212 and the trailer upper coupler mounting plate 216 is welded to both trailer upper coupler crossmember 214 and the trailer frame 212. One skilled in the art may use other methods to rigidly affix the trailer upper coupler crossmember 214 to the trailer frame 212.

A plurality of vertical members 218 may be rigidly affixed to the external longitudinal frame skids 204 and the trailer assembly 102. The vertical members 218 may extend upwards from the external longitudinal frame skids 204 and the trailer assembly 102 to engage horizontal longitudinal members 220 directly above the external longitudinal frame skids 204 and a horizontal lateral member 222 directly above the trailer assembly 102. Preferably, the vertical members 218 are welded to the external longitudinal frame skids 204 and the trailer assembly 102. Other methods of affixation known to one skilled in the art may be used to rigidly affix the vertical members 218.

In the front of the trailer assembly 102, the horizontal lateral member 222 may engage and be rigidly affixed to the horizontal longitudinal members 220 to substantially surround the tank 108 to prevent movement both laterally and longitudinally. Additionally, a plurality of saddle support members 224 may be rigidly affixed to the vertical members 218 and the external crossmembers 208 to support the tank 108 installed on the trailer assembly 102, A saddle support member 224 preferably has three sides with two of the edges creating a right triangle and the hypotenuse edge being contoured to the circumference of the tank 108 to cooperatively engage the tank 108 to prevent lateral movement by cradling the tank 108.

At the distal end of the trailer assembly 102 and at approximately the same height of the horizontal longitudinal member 220, a rear platform 226 may be rigidly affixed to the trailer assembly 102. The rear platform 226 may extend longitudinally from the trailer assembly 102 with substantially the same width as the trailer assembly 102 and above the rear axle assembly 104 sized to accommodate the scrubber system 110 and the stairway 112.

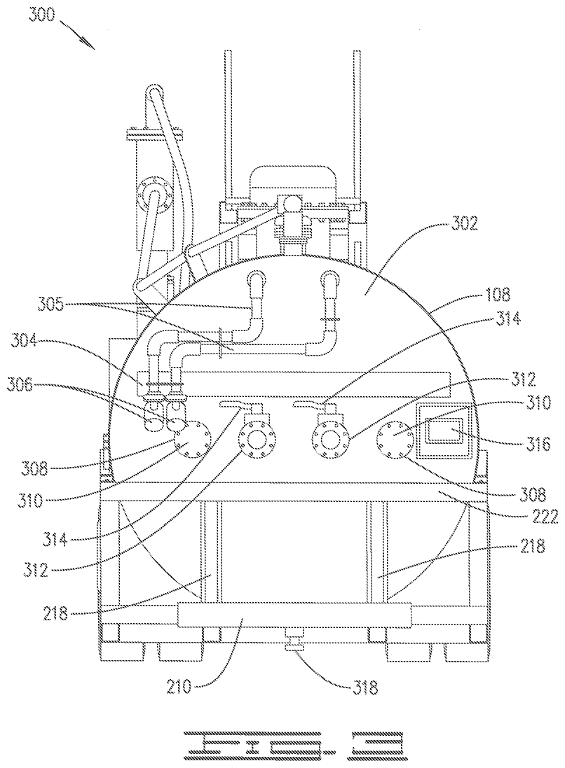

FIG. 3 is the towable fluid storage tank trailer front end 300. The trailer front end 300 may comprise the proximate tank end 302, the tank structural support 304, tank fill lines 305, outer suction lines 308 with block-off plates 310, inner suction lines 312 with valves 314, and a system controller 316. As described above, vertical members 218 are preferably rigidly affixed to the horizontal lateral member 222 and the horizontal longitudinal members 220, preventing movement of the tank longitudinally in the forward direction toward the towed vehicle.

The kingpin 318 may be rigidly affixed to the upper coupler 210. The kingpin 318 and upper coupler 210 allow a semi-tractor's fifth wheel to engage the towable fluid storage tank trailer 100 and secure the trailer 100 for transportation. Typically, a semi-tractor with a wench or some other lift method may be attached to the trailer front end 300 and lift the trailer front end 300 towards the semi-tractor. As the wench cable is retracted, the trailer front end 300 is lifted, the towable fluid storage tank trailer 100 with kingpin 318 is pulled toward to the semi-tractor's fifth wheel. The upper coupler 210 initially engages the semi-tractor's fifth wheel and slides along the top of the fifth wheel until the kingpin 318 engages the guides on the fifth wheel guiding the kingpin 318 to its final locking position on the fifth wheel position.

A tank structural support 304 may be affixed to the proximate tank end 302 to provide rigidity in the proximate tank end 302 and prevent the proximate tank end 302 from bowing outward during filling operations and bowing inward as the fluid is removed. In the preferred embodiment, the tank structural support 304 is rectangular and a length that substantially extends from the right side of the tank 108 to the left side and is positioned approximately two-thirds the distance from the bottom of the tank 108. In this embodiment, a tank structural support 304 is parallel to the horizontal lateral member 222. One skilled in the art may select other locations to emplace the structural support 304.

Tank fill lines 305 are fluidly connected to the interior of the tank 108 and may be connected to an external fluid source through the tank fill line valves 306. In the preferred embodiment, the tank fill lines 305 are rigidly affixed to tank fill line valves 306 with an external connection that may be a national pipe thread. One skilled in the art may use different types of connections including, but not limited to, quick-disconnects. The tank fill lines 305 receive the fluid from the external fluid source and directs the fluid into the upper most part of proximate tank end 302 where the fluid exits the tank fill lines 305 to fill the interior of tank 108. A plurality of outer suction lines 308 and inner suction lines 312 are preferably positioned below the tank structural support 304 and the tank acid fill line valves 306. The inner suction lines 312 and outer suction lines 308 allow the fluid to be added to and removed from the interior of the tank 108. To seal an outer suction line 308 external connection, a block-off plate 310 may be removably affixed to prevent the fluid from exiting. The inner suction lines 312 may have valves 314 removably affixed to control the flow of the fluid and seal the external connection. A valve similar to the one used for the inner suction lines 312 may be used instead of a block-off plate 310 to control the flow of the fluid. As with the outer suction lines 308, the valves 314 may be replaced with block-off plates 310. The inner suction lines 312 may be substantially centered within the proximate tank end 302 both horizontally and vertically. The inner suction lines 312 may be positioned and in-line with outer suction lines 308. The inner suction lines 312 allow the lowest point of removal within the tank 108 for the fluid. In the preferred embodiment, the external connection of the inner suction lines 312 may be fluidly connected to plurality of mechanical valves 314 external to the tank 108. In an alternative embodiment the valves 314 controlling the flow of fluids may be replaced with other control valves including, but not limited to, electromechanical, electro-pneumatic, electro-hydraulic, and a combination thereof, known to one skilled in the art. The outer suction lines 308 are position to the outside of the inner suction lines 312 and allow a fluid at a higher level to be removed from and added to the tank 108. In the preferred embodiment, during transport the outer suction lines 308 have block-off plates 310 and the inner suction lines 312 have valves 314 that are closed during transport. When the towable fluid storage tank trailer 100 is to transport water, the outer suction lines 308 and inner suction lines 312 may be used to fill the tank 108. However, when transporting fluids such acid or chemicals, the tank 108 may be filled with water before the addition of the caustic fluids to help dilute the fluids as they are filled minimizing potential damage to the interior of the tank. As the tank 108 is filled with chemicals, vapors and fumes are created which creates a significant risk to personnel and the environment. The vapors and fumes tend to accumulate and concentrate as the fluid level fills the tank 108. The vapors and fumes as the fluid rises are forced upwards and confined to the top of the tank 108 and exit through the scrubber tank outlet 412. The scrubber system 110 is described in greater detail below.

The system controller 316 may comprise a display section, a user interface, a communication section, memory section, power section, sensing section, and a control section. The display section may display the current level of the fluid in the tank 108. The user interface allows personnel to program the system controller 316 to receive sensor inputs, display desired information, communicate remotely to a smart device including but not limited to a smartphone, tablet, and laptop, and control devices including but not limited to the scrubber system 110 and the valves 314. The memory section may store the operating system and programs created by personnel. The power section may provide power to the system controller 316, but may also provide power to the sensors, and control devices. The sensing section receives sensor inputs from devices including, but not limited to, a fluid level indicator 404 and provides the information to the system controller 316 for use by personnel. The control section provides control signals to control devices including but not limited to electro-mechanical valves and scrubber power controls. More specifically, the control signal from the system controller 316 to the control valve 314 may instruct the valve 314 to open and close and a control signal to the scrubber system 110 may initiate and cease operations.

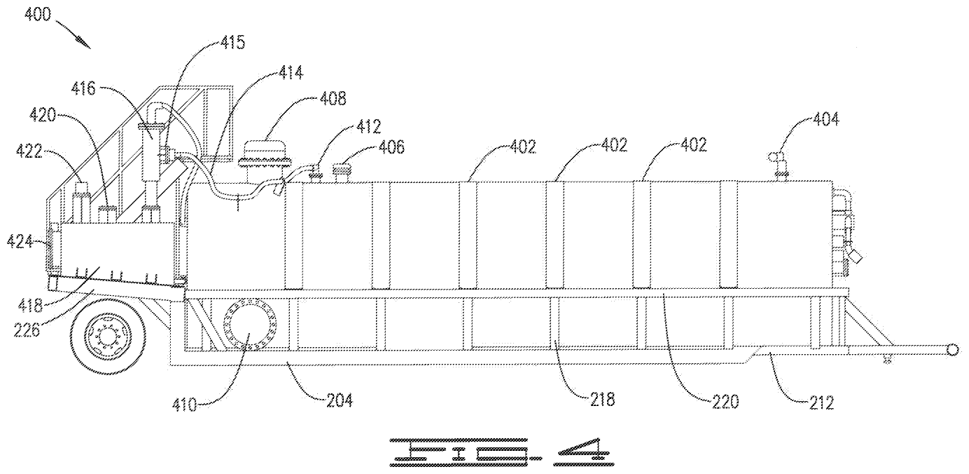

FIG. 4 is a view of the tanker trailer left side 400. This view shows the trailer frame 212 which extends from frame skids 202 and 204 and integrates with and may be rigidly affixed to the upper coupler 210. Shown in this view area plurality of tank retention straps 402, a fluid level indicator 404, a blow-off valve 406, an upper manway 408, a lower manway 410 and a scrubber tank outlet 412. Further illustrated is the scrubber system 110 comprising scrubber tubing 414, a scrubber 416, a scrubber holding tank 418, a scrubber holding tank fill port 420, a scrubber holding tank fill vent 422 and the scrubber holding tank cleanout 424.

Tank retention straps 402 may removeably affix the tank 108 to the trailer assembly 102 and tank support structure 106 and prevent movement of the tank 108. The tank retention straps 402 may be removably affixed using a plurality of fasteners including, but not limited to, nuts and bolts to secure tank retention straps 402 to the horizontal longitudinal members 220. In the preferred embodiment, there is a plurality of tank retention straps 402 to hold and maintain the tank 108 in a desired position to prevent movement of the tank 108 from shifting forward and aft and side to side. The tank retention straps 402 have a complementary radius to engage the external radius of the tank 108. Additionally, the tank retention straps 402 prevent the tank 108 from rotating inside the tank support structure 106 and the trailer assembly 102. The tank retention straps 402 may extend from the right-side horizontal longitudinal member 220 of the trailer assembly 102, to the left-side horizontal longitudinal member 220 of the trailer assembly 102 over the top of the tank 108 to cooperatively engage the tank 108.

The fluid level indicator 404 is preferably positioned on top and near the front of a tank 108. The fluid level indicator 404 detects the amount of fluid in the tank 108 during loading, unloading, and normal operations and displays the information to personnel. The fluid level indicator 404 may be selected from a gas level gauge, float, displacers, bubblers, differential pressure transmitters, load cells, magnetic level gauge, capacitance transmitters, magnetostrictive level transmitters, ultrasonic level transmitters, radar level, and laser level transmitter. In the preferred embodiment, the fluid level indicator 404 is a laser level. Preferably the fluid level indicator 404 is electrically connected to the system controller 316 where the fluid level information is sent to the system controller 316 for display.

The blow-off valve 406 may be positioned on a top and substantially near the rear of the tank 108. The blow-off valve 406 may prevent over-pressurization or vacuum during normal operations, loading and unloading, and in emergency situations. The blow-off valve 406 may allow some pressure to escape from the tank 108 when the tank 108 is being loaded and unloaded with fluid thereby releasing the pressure and preventing a rupture of the tank 108. This blow-off valve 406 may minimize the possibility of rupturing the tank 108 when loading the fluid. The blow-off valve 406 may also prevent the tank 108 from collapsing when fluid is unloaded. The blow-off valve 406 may allow external atmosphere to enter the tank 108 at a sufficient rate to prevent the tank 108 from collapsing and potentially discharging the fluid. During normal operations, the external temperature may fluctuate increasing and decreasing the pressure inside the tank 108 and the blow-off valve 406 may allow pressure or vacuum relief as the external conditions change without being constantly monitored.

Preferably an upper manway 408 may be positioned on the top and substantially near the distal end of the tank 108. A lower manway 410 may be positioned on the left side near the bottom substantially near the end of the tank 108. The manway 408 and 410 allow personnel to enter the interior of the tank 108 to perform cleaning, inspections, and repair operations. When not being accessed, the lower manway 410 may be sealed with a cover and a plurality of fasteners. The upper manway 408 may have a access port that is removably affixed to the upper manway 408 on the top of tank 108. A cover may be hingedly affixed to the access port allowing quick access for personnel to the cavity of the tank 108 and the cover may be secured with a plurality of wingnuts positioned around the cover. The upper manway 408 may provide quick access to the interior of the tank 108 by personnel during normal operations, loading and unloading, and in emergency situations.

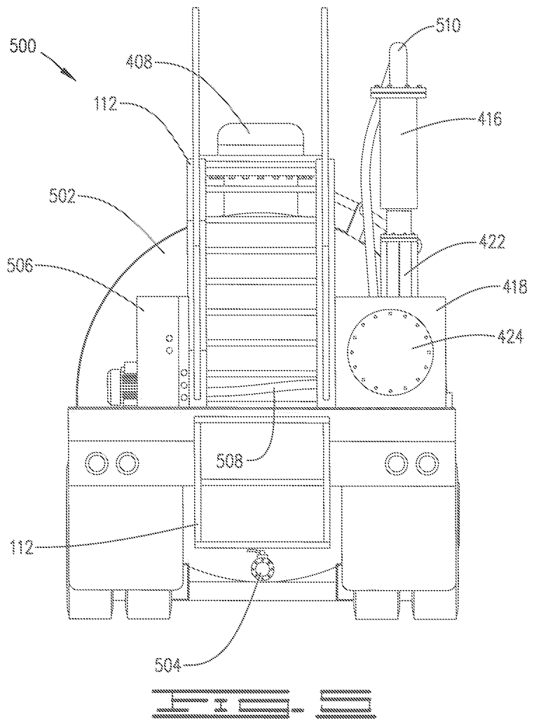

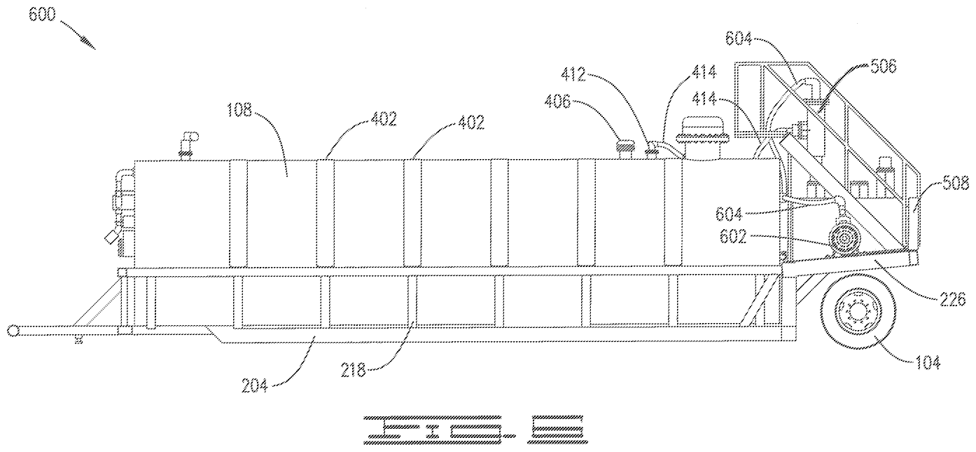

The scrubber system 110 may comprise multiple components that are described in a series of figures including this figure and FIGS. 5 and 6. The scrubber system 110 may utilize a solution to neutralize the fumes and vapors produced by the fluid in the tank 108 at any time during normal operations, loading, unloading and emergency situations. The scrubber tank outlet 412 is preferably positioned on the top and substantially near the rear of the tank 108 and preferably between the upper manway 408 and the blow-off valve 406. The scrubber tank outlet 412 and the scrubber tubing 414 fluidly connect the tank 108 to the scrubber 416 allowing fumes and vapors to exit the tank 108 and enter the scrubber 416. As part of the scrubber system 110, a scrubber holding tank 418 retains corrosive material and the neutralizing solution which is typically water and a caustic soda. One skilled in the art will recognize other solutions and neutralizing agents may be used the neutralize the fluid, depending on the type of fluid being transported. The scrubber holding tank 418 may comprise a scrubber holding tank fill port 420, a scrubber holding tank fill vent 422 and the scrubber holding tank cleanout 424. The scrubber holding tank fill port 420 may allow the scrubber holding tank 418 to receive the neutralizing agent and delivery system such as water and retain the neutralizing solution until needed. The scrubber holding tank fill vent 422 may allow the pressure to be released as the scrubber holding tank 418 is being filled to prevent the scrubber holding tank 418 from rupturing. After using the neutralizing solution, the scrubber holding tank cleanout 424 may be used to remove any byproducts created from the neutralization process.

FIG. 5 is the towable fluid storage tank trailer rear end 500. The trailer rear end 500 may comprise distal tank end 502, a drain valve 504, a stairway 112, and the scrubber system 110 components not described earlier in FIG. 4. The additional scrubber system 110 components may further compromise a scrubber pump control 506, a scrubber tank pump connection 508, and a scrubber input 510. The drain valve 504 may be removably affixed to the distal tank end 502, preferably at the lowest point on the distal tank end 502 to allow fluid that could not be siphoned, to be drained out through this drain valve 504. The drain valve 504 may be replaced with remotely controllable valve described earlier and controlled from the system controller 316. A stairway 112 allows personnel to transition from the ground at the rear of the towable fluid storage tank trailer 100 to the top of the tank 108 and provides access to the upper manway 408, scrubber tubing 414, scrubber tank outlet 412, blow-off valve 406 and the fluid level indicator 404 for inspections, removal, replacement, and repairs. In this preferred embodiment, the stairway 112 comprises handrails on both sides of the stairway 112, stringers, and treads. The treads may be selected from solid or grated material. Preferably, the treads are grated to prevent slipping under field conditions and the treads in cooperation with handrails may prevent personnel from falling into the scrubber 416, potentially causing harm to personnel and potentially damaging the scrubber system 110.

Preferably the scrubber pump control 506 initiates and ceases the operation of the scrubber pump 602. The scrubber pump 602 may be controlled manually or through the system controller 316. The scrubber tank pump connection 508 fluidly connects the scrubber holding tank 418 to the scrubber pump 602. The scrubber input 510 is fluidly connected to the scrubber pump 602 via the pump scrubber connection 604. Personnel fill the scrubber holding tank 418 with the neutralizing solution. As the tank 108 is filling with acid or chemical fluid, the personnel may initiate the scrubber pump 602 using the scrubber pump control 506 or the system controller 316. Neutralizing solution is removed from the scrubber holding tank 418 through the scrubber tank pump connection 508 via a vacuum created by the scrubber pump 602. The solution is then forced by the scrubber pump 602 through the pump scrubber connection 604 to the scrubber input 510. The solution is forced down through the scrubber 416 and its internal sprayers disperse the solution to more readily interact and neutralize the fumes and vapors coming from the tank 108. Additionally, the solution passes the tank inlet 415, creating a vacuum and removing the fumes and vapors from the tank 108 to further react with the solution. The solution then re-enters the scrubber holding tank 418 and the process continues until personnel cease operation of the scrubber pump 602. The solution is continually recycled while the scrubber pump 602 is in operation. The scrubber holding tank 418 retains the neutralized fluids after neutralization. Personal may initiate the scrubber pump 602 at any time during normal operations, loading, unloading and emergency situations.

FIG. 6 is the tanker trailer right side 600. This view further illustrates the tank retention straps 402 being removably affixed to the right-side horizontal longitudinal member 220. The scrubber pump 602 may be rigidly affixed to the rear platform 226 and the pump scrubber connection 604 may be routed under the stairway 112 and up to the scrubber input 510. The scrubber pump 602 may be powered by alternating current or direct current. The power may be supplied by the tow vehicle and from an onsite source.

Having thus described the invention, I claim:

1. A Towable Fluid Storage Tank Trailer comprising:
a. a cylindrical horizontal storage tank having—
i. cylindrical walled outer structure creating an inner cavity,
ii. a distal end,
iii. a proximal end,
iv. at least one external fluid connection to the inner cavity, and
v. at least one access point to the access to the inner cavity;
b. a tank support structure substantially surrounding and engaging the storage tank having—
i. at least one tank support member engaging the underside of the tank and positioning the tank within a support structure,
ii. at least one tank coupling member, removably securing the tank in a desired position and orientation to a trailer assembly,
iii. at least one lateral retention member preventing movement in the longitudinal axis,
iv. at least one longitudinal retention member preventing movement in the lateral axis, and
v. a tank access means for reaching the top of the tank; and
c. a towable trailer assembly having—
i. abase,
ii. a ground engagement means for a trailer after being removed from the tow vehicle to safely and securely engage the ground beneath the trailer,
iii. a tow vehicle engagement means, and
iv. at least one set of rear wheels removably affixed to the base to engage the ground for rolling movement relative thereto,
whereby the storage tank is horizontally disposed within the tank support structure and is removably coupled to the support structure that is rigidly affixed to the towable trailer assembly where various types of caustic and non-caustic fluids are filled and transported.

2. The Towable Fluid Storage Tank Trailer of claim 1, where the cylindrical storage tank is selected from ferrous metal and non-ferrous metal, composite, carbon fiber, fiberglass, and polymer.

3. The Towable Fluid Storage Tank Trailer of claim 1, where the cylindrical storage tank may receive, in the cavity therein, a fluid.

4. The Towable Fluid Storage Tank Trailer of claim 3, where the fluid is selected from caustic and non-caustic.

5. The Towable Fluid Storage Tank Trailer of claim 1, where the tank support member has a circumference to cooperatively engage the storage tank.

6. The Towable Fluid Storage Tank Trailer of claim 1, where the tank support structure includes longitudinal, lateral, and vertical members maintaining the position of the tank.

7. The Towable Fluid Storage Tank Trailer of claim 1, where the trailer assembly includes a rear axle assembly positioned to lower the tank member to the ground substantially level.

8. The Towable Fluid Storage Tank Trailer of claim 1, where the valves controlling the flow of fluids may be selected from electromechanical, electro-pneumatic, and electro-hydraulic.

9. The Towable Fluid Storage Tank Trailer of claim 1, where a fluid level indicator is positioned on the tank to detect the level of fluid within.

10. The Towable Fluid Storage Tank Trailer of claim 9, where a fluid level indicator is selected from a gas level gauge, float, displacers, bubblers, differential pressure transmitters, load cells, magnetic level gauge, capacitance transmitters, magnetostrictive level transmitters, ultrasonic level transmitters, radar level, and laser level transmitter.

11. The Towable Fluid Storage Tank Trailer of claim 1, where the fumes and vapors of a fluid are neutralized by a scrubber.

12. The Towable Fluid Storage Tank Trailer of claim 11, where the neutralized fluids are stored is a vessel suitable for corrosive material.

13. The Towable Fluid Storage Tank Trailer of claim 11, where a pump injects a neutralizing agent from a storage vessel into the scrubber.

14. Towable Fluid Storage Tank Trailer of claim 1, where the top of the tank is accessed by a stairway.

15. The Towable Fluid Storage Tank Trailer of claim 14, where the stairway treads are solid or grated.

16. A Towable Fluid Storage Tank Trailer comprising:
a. a cylindrical horizontal storage tank having—
i. a cylindrical walled outer structure creating an inner cavity,
ii. a distal end fixedly engaging the cylindrical walled outer structure to enclose and seal the distal end of the storage tank,
iii. a proximal end fixedly engaging the cylindrical walled outer structure to enclose and seal the proximal end of the storage tank,
iv. at least one manway, and
v. a plurality of connections fluidly connecting the interior cavity to the storage tank to the exterior;
b. a tank support structure substantially surrounding and engaging the storage tank having—
i. a plurality of saddle support members,
ii. a plurality of tank retention straps to removably couple the storage tank to the tank support structure,
iii. a plurality of vertical members,
iv. at least one lateral member, and
v. at least one longitudinal member;
c. a towable trailer assembly having—
i. a plurality of skids,
ii. a plurality of horizontal trailer crossmembers,
iii. a upper coupler mounting plate to removably engage a tow vehicle, and
iv. at least one set of rear wheels and axle assembly removably affixed to the trailer assembly to engage the ground for rolling movement relative thereto,
d. at least one fluid level indicator system; and
e. a scrubber to neutralize the fumes and vapors of the fluid being transported,
whereby the storage tank is horizontally disposed on and within the tank support structure and is removably affixed to the support structure that is rigidly affixed to the towable trailer assembly where various types of caustic and non-caustic fluids are filled and transported.
